(19) United States
(12) Patent Application Publication
(10) Pub. No.: US 2005/0025164 A1
(43) Pub. Date: Feb. 3, 2005

(54) Seamless hand-off of mobile node to a wireless local area network (WLAN)

(75) Inventors: Alan Kavanagh, Montreal (CA); Suresh Krishnan, Montreal (CA)

Correspondence Address: ALEX NICOLAESCU;Ericsson Canada Inc., Patent Department (LMC/M/P), 8400 Decarie Blvd., Town Mount Royal, QC, H4P 2N2, CA

(73) Assignee: Telefonaktiebolaget L M Ericsson (publ)

(21) Appl. No.: 10/712,954

(22) Filed: Nov. 14, 2003

Related U.S. Application Data
(60) Provisional application No. 60/487,241, filed on Jul. 16, 2003.

(51) Int. Cl. H04L 12/56

(52) U.S. Cl. 370/401

(57) ABSTRACT

A method and system for seamlessly handing off a Mobile Node (MN) equipped with a Wireless Local Area Network (WLAN) adaptor from a cellular network such as a GRPS/UMTS network to a WLAN network without interrupting the ongoing IP connection/session. When entering a WLAN coverage area, the roaming MN sends mobility information to a WLAN Integration Gateway (WIG) node allowing the WIG node to identify the source Service GPRS Support Node (SGSN). The WIG node contacts the source SGSN to obtain PDP Context information relative to the roaming MN, and establishes a new GTP tunnel with the servicing GGSN in order to complete the handoff. The WIG node may route data traffic for the MN by assigning a new IP address to the MN and by either performing IP-in-IP encapsulation or Network Address Translation (NAT).

### PRIORITY STATEMENT UNDER 35 U.S.C. S.119(e) & C.F.R. S.1.78

This non-provisional patent application claims priority based upon the prior U.S. provisional patent application entitled “WIG NODE”, application No. 60/487,241, filed Jul. 16, 2003, in the names of Alan KAVANAGH and Suresh KRISHNAN.

### BACKGROUND OF THE INVENTION

1. Field of the Invention

The present invention relates to a method and system for handing-off a Mobile Node (MN) from a cellular network to a Wireless Local Area Network (WLAN).

2. Description of the Related Art

A Wireless Local Area Network (WLAN) is a Local Area Network (LAN) to which a mobile user can connect through a wireless (radio) connection. The Institute of Electrical and Electronics Engineers (IEEE) has defined several sets of standard specifications, such as for example 802.11, 802.16, and 802.20, that specify the technologies to be used for WLANs. For example, in the set of standard specifications 802.11, there are currently four specifications: 802.11, 802.11a, 802.11b, and 802.11g, all of which are herein included by reference. All four use the Ethernet protocol and CSMA/CA (Carrier Sense Multiple Access with Collision Avoidance) for path sharing.

The most recently approved standard, 802.11g, offers wireless transmission over relatively short distances at up to 54 megabits per second (Mbps) compared with the 11 megabits per second of the 802.11b standard. Like 802.11b, 802.11 g operates in the 2.4 GHz range and is thus compatible with it.

The 802.11b standard—often called Wi-Fi (Wireless Fidelity) uses a modulation called Complementary Code Keying (CCK), which allows higher data speeds and is which is less susceptible to multipath-propagation interference, while the modulation used in 802.11 has historically been phase-shift keying (PSK).

The 802.11a specification applies to wireless ATM systems and is used in access hubs. 802.11a operates at radio frequencies between 5 GHz and 6 GHz. It uses a modulation scheme known as Orthogonal Frequency-Division Multiplexing (OFDM) that makes possible data speeds as high as 54 Mbps, but most commonly, communications takes place at 6 Mbps, 12 Mbps, or 24 Mbps.

Wi-Fi (short for “wireless fidelity”) is the popular term for a high-frequency WLAN. The Wi-Fi technology is rapidly gaining acceptance in many companies as an alternative to a wired LAN. Wi-Fi can also be installed in a home network.

The use of WLANs with high-bandwidth allocation for wireless service makes possible a relatively low-cost radio connections for WLAN users which terminals are equipped with WLAN adapters. Such adapters can be made to fit on a Personal Computer Memory Card Industry Association (PCMCIA) card for laptop or notebook computers. In actual fact, more and more computer equipment providers, such as for example IBM, Toshiba, and Dell commercialize personal computers with embedded WLAN adaptors, while more and more Personal Digital Assistants (PDAs) comprise WLAN cards as well.

On the other hand, today's mobile network operators are facing a strong challenge in deploying Third Generation (3G) cellular networks due to the associated deployment costs. Infrastructure for 3G networks such as GPRS/UMTS (General Packet Radio Service or Universal Mobile Telephone System) is expensive and represents an actual burden for the cellular network operators. This problem is further amplified by radio coverage requirements imposed by governmental agencies on network operators, who are often requested to insure total radio coverage even in areas where the expected traffic does not justify such coverage.

WLAN has gained enormous ground not only in market acceptance for deployment of WLAN Access Points (AP) for SOHO (small office home office) use, but also into the every day consumer communication products. WLAN has now become an accepted technology. However, with the current cost burden of building and deploying a 3G network, 3G operators may not have the same luxury of deploying multiple 3G base stations to solve network congestion where both voice and data will compete for the same traffic channels.

A solution to ease the burden of congestion in 3G radio cells is to allow WLAN to be overlapped in high-density areas such as metropolitan areas where cell congestion becomes increasingly common. Integrating WLAN to cover areas where radio coverage is heavily competed for both voice and data can allow network operators to deploy sufficient radio coverage quickly and easily using WLAN. This has the advantage to offload data traffic from the cellular network when congestion occurs, so that a reliable voice service can still be provided over the cellular network.

However, in such an architecture wherein a cellular network overlaps a WLAN cell, also called herein a WLAN (or Wi-Fi) hotspot, an issue arises with the connectivity between the cellular network and the WLAN. For example, a user equipped with a WLAN compatible Mobile Node (MN) may roam from a cellular radio cell into the WLAN hotspot. With the existing implementations, the original IP connectivity of the MN with the cellular network must first be interrupted, and then, a new IP connection reinitiated between the MN and the WLAN. This is due to the lack of cohesion between GPRS/UMTS and WLAN, which prevents the mobility information from being propagated between the cellular and WLAN networks. For example, in GPRS, when an MN is handed-off from a source SGSN to a target SGSN, the latter inquires and receives from the former the MN context information. This is however not possible when the target node is a WLAN node, because the GPRS/UMTS network does not communicate with the WLAN at all. The result is the IP connection interruption, which may cause undesired effects not only when the user is carrying out a live voice or data conferencing, but also in applications such as file downloads or uploads, multimedia session, etc.

One possible solution to cope with the cellular-to-WLAN connectivity is to use Mobile IP. Mobile IP is an Internet Engineering Task Force (IETF) standard communications protocol that is designed to allow mobile device users to move from one network to another while maintaining their permanent IP address. Defined in the Request for Comments (RFC) 2002, Mobile IP is an enhancement of the Internet Protocol (IP) that adds mechanisms for forwarding Internet traffic to MNs when they are connecting through other than their home network. In traditional IP routing, IP addresses represent a topological point of attachment. Routing mechanisms rely on the assumption that each network node will always have the same point of attachment to the Internet, and that each node's IP address identifies the network link where it is connected. Core Internet routers look at the IP address prefix, which identifies a device's network. At the network level, routers look at the next few bits to identify the appropriate subnet. Finally, at the subnet level, routers look at the bits identifying a particular device. In this routing scheme, if a mobile device is disconnected from the Internet and later desires to reconnect through a different subnet, that device must be re-configured with a new IP address, the appropriate netmask and default router. Otherwise, routing protocols have no means of delivering packets because the device's IP address lacks the necessary information about the current point of attachment to the Internet.

All the variations of Mobile IP assign each mobile node a permanent home address on its home network and a care-of address that identifies the current location of the device within a network and its subnets. Each time a user moves the device to a different network, it acquires a new care-of address. A mobility agent on the home network associates each permanent address with its care-of address. The mobile node sends the home agent a binding update each time it changes its care-of address using Internet Control Message Protocol (ICMP). In Mobile IPv4, traffic for the mobile node is sent to the home network but is intercepted by the home agent and forwarded via tunnelling mechanisms to the appropriate care-of address. Foreign agents on the visited network help to forward datagrams.

However, Mobile IP requires significant changes to the mobile operator's network., which translates into substantial investment and time and a complete network re-design. For example, today's GRPS/UMTS networks lack functionalities such as the Home Agent (HA) and the Foreign Agent (FA), which are essential for Mobile IP. Instead, current GPRS/UMTS networks use GTP for mobility management.

Accordingly, it should be readily appreciated that in order to overcome the deficiencies and shortcomings of the existing solutions, it would be advantageous to have a method and system for effectively providing seamless connectivity for mobile nodes roaming from cellular networks into WLAN hotspots and vice versa. The present invention provides such a method and system.

### SUMMARY OF THE INVENTION

In one aspect, the present invention is a method for handing off a Mobile Node (MN) from a cellular network to a Wireless Local Area Network (WLAN), the method comprising the steps of:
a) receiving at a WLAN Integration Gateway (WIG) node mobility information relative to the MN;
b) identifying by the WIG node a source Service GPRS Support Node (SGSN) that lastly serviced the MN in the cellular network based on the mobility information;
c) obtaining by the WIG node Packet Data Protocol (PDP) Context information relative to the MN from the identified source SGSN;
d) establishing a GPRS Tunnelling Protocol (GTP) tunnel for use by the MN between the WIG node and a Gateway GPRS Support Node (GGSN).

In another aspect, the invention is a Wireless Local Area Network Integration Gateway (WIG) node for use in a Wireless Local Area Network (WLAN), the WIG node comprising:
a WLAN functionality for supporting WLAN data communications with WLAN clients, the WLAN functionality receiving mobility information relative to a roaming Mobile Node (MN) equipped with a WLAN client;
a service layer identifying based on the mobility information a source Service GPRS Support Node (SGSN) that lastly serviced the MN in a cellular network; and
a GTP stack module for supporting General Packet Radio Service (GPRS) Tunnelling Protocol (GTP) communications with a Gateway GPRS Support Node (GGSN), the GTP stack obtaining Packet Data Protocol (PDP) Context information relative to the MN from the identified source SGSN, and establishing with the GGSN a GTP tunnel for use by the MN.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is an exemplary high-level network diagram illustrative of a Mobile Node (MN) hand-off from a cellular network to a Wireless Local Area Network (WLAN) according to the preferred embodiment of the present invention;

FIG. 2 is an exemplary nodal operation and signal flow diagram illustrative of the MN hand-off from the cellular network to the WLAN according to the preferred embodiment of the present invention;

FIG. 3 is an exemplary high-level representation of mobility information sent from the MN to the WLAN in relation with the handoff from the cellular network to the WLAN according to the preferred embodiment of the invention; and

FIG. 4 is an exemplary nodal operation and signal flow diagram of various possible routing mechanisms used by the present invention.

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention provides a method and a WLAN Integration Gateway (WIG) node that allows a Mobile Node (MN) to seamlessly roam between General Packet Radio Service (GPRS) based networks (including a Universal Mobile Telephone System—UMTS—or any other suitable type of digital cellular network) toward a Wireless Local Area Network (WLAN). The present invention further allows Mobile Network Operators (MNO) to integrate WLAN transparently to the MN subscribers without impacting the mobile network architecture and design, as well as transparently delivering Third Generation (3G) services over the WLAN. For these purpose, the present invention handles a handoff between GPRS networks and WLANs by using GPRS Tunnelling Protocol (GTP) between the WIG node and the GPRS Support Nodes (such as the Service GPRS Support Node (SGSN) and the Gateway GPRS Support Node (SSGS)) of the GPRS/UMTS networks.

Furthermore, the present invention does not affect the existing GPRS/UMTS network architecture or the associated services, which allows the MNOs to easily integrate WLAN functionality into the existing GPRS/UMTS network by using the WIG node according to the invention. It also allows the MNOs to deliver 3G services seamlessly to the MN users when the MNs are equipped with a WIG client capable of supporting WLAN service. The WIG node of the present invention provides seamless connectivity and transparency between the WLAN and GPRS/UMTS networks using GTP, by connecting the MN via the WLAN to a GGSN.

According to the present invention, the WIG node supports a Gn interface towards the GPRS/UMTS network and directly interfaces with the SGSN and GGSN nodes, and also supports mobility between the GPRS/UMTS network when the MN roams from an SGSN (GPRS/UMTS) routing area into a WLAN routing area. The mobility is handled using GTP between the WIG node and the GSN nodes of the GPRS/UMTS network. In the WLAN network, the mobility between different APs is handled as part of any one of the possible WLAN specifications, as described hereinbefore.

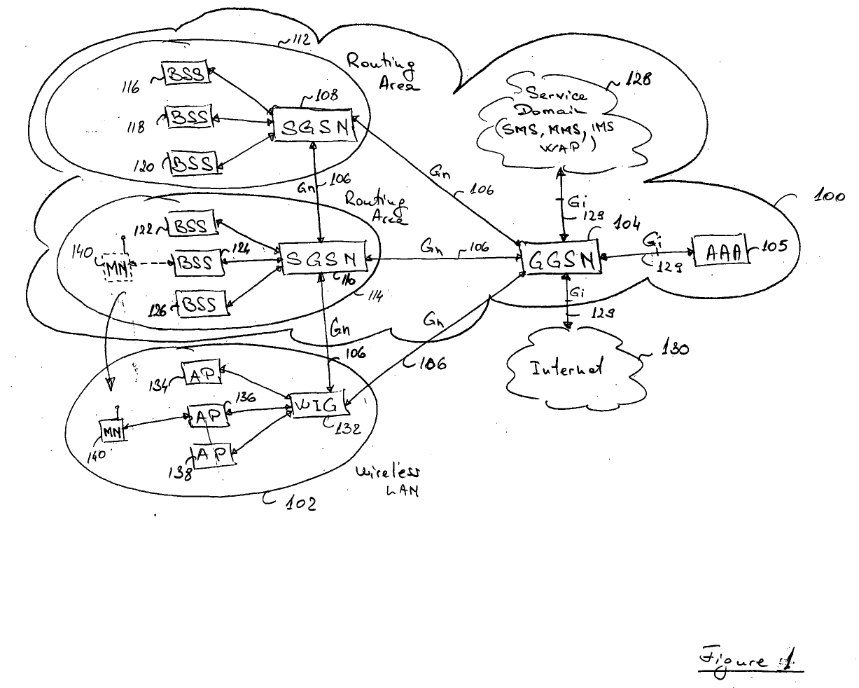

Reference is now made to FIG. 1, which is an exemplary high-level network diagram illustrative of a mobile node hand-off from a cellular network 100 to a WLAN 102 according to the preferred embodiment of the present invention. Shown in the GPRS/UMTS cellular network 100, is first a GGSN node 104 that connects via a Gn interface 106 to a first SGSN 108 and to a second SGSN 110, each servicing a corresponding routing area 112 and 114 respectively. The SGSN 108 is further connected to a plurality of Base Station Subsystems (BSSs) 116-120 that provide radio coverage to a plurality of cellular radio cells (not shown), while the SGSN 110 is analogously connected to its own BSSs 122-126. The SGSNs 108 and 110 also connect to each other via a Gn interface 106. As it is well known in the art, the GGSN node 104 may also be linked via a Gi interface 129 to a service domain 128 responsible for providing different kinds of services to subscribers of the cellular network 100, such as for example Short Message Service (SMS), Multimedia Messaging Service (MMS), IP Multimedia Service (IMS), or Wireless Application Protocol (WAP) services. An authorization, Authentication and Accounting server (AAA) 105 is also connected the GGSN node 104 via a Gi interface 129 and is capable of authorizing, authenticating and recording accounting information regarding the mobile subscribers of the network 100. The GGSN 104 also connects via similar Gi interface 129 to the Internet 130 that subscribers of the cellular network 100 can access via their mobile nodes.

According to the preferred embodiment of the present invention, there is provided a WIG node 132 responsible for supporting WLAN data communications with mobile nodes equipped with a WLAN adapter in a WLAN coverage area 102. For example, a mobile node 140 may receive cellular radio service from the cellular network 100 while physically residing in the radio coverage area of that network, but can further receive WLAN radio service when roaming in the coverage area of the WLAN 102. The WIG node 132 connects to a plurality of Access Points (AP) 134-138, which are responsible for providing wireless layer 2 connectivity to the mobile node. The WIG node 132 is also linked to the GGSN node 104 and to the SGSN 110 via a Gn interface 106 and is capable of supporting GTP tunneling with the GGSN 104.

According to the present invention, when the mobile node 140 roams from a source routing area 114 of the source cellular network 100 into a target WLAN coverage area 102, the mobile node 140 broadcasts mobility information regarding its source routing area 114 in order to inform the WIG node 132 of the identity of the source SGSN that needs to be contacted to acquire PDP Context information related to the mobile node. Provided with the mobility information of the mobile node 140, the target WIG node 132 is capable of identifying and contacting the appropriate source SGSN 110, as well as the appropriate GGSN 104, in order to successfully complete the mobile node handoff to the WLAN, in a manner which is yet to be described.

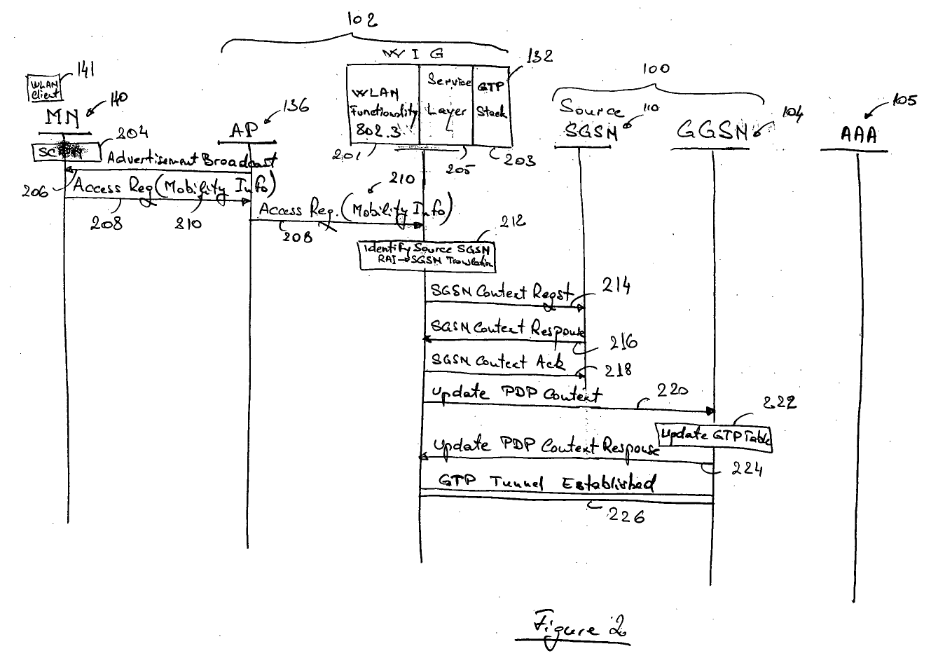

Reference is now made to FIG. 2, which is an exemplary nodal operation and signal flow diagram illustrative of the mobile node 140 hand-off from the cellular network 100 to the WLAN 102 according to the preferred embodiment of the present invention. Shown in FIG. 2 is the mobile node 140, which is in the process of roaming from a cellular network 100 to the WLAN 102, and more specifically from a radio cell of the BSS 124 of the source routing area 114 serviced by the source SGSN 110, to the coverage area, or hotspot, of the AP 136 connected to the target WIG node 132, all of which are better shown in relation to FIG. 1.

With reference to FIG. 2, the WIG node 132 comprises a WLAN functionality 201 for supporting WLAN digital communications with mobile nodes equipped with a WLAN adaptor (also called herein WLAN client), which communications that may be made according to the IEEE specifications 802.3, herein included by reference. The WIG node 132 further comprises a GTP stack 203 capable of supporting GTP communications with external GSN nodes. Finally, the WIG node 132 comprises a service layer functionality 205 responsible for service features such as for example Remote Authentication Dial-In User Server/Service (RADIUS), Dynamic Host Configuration Protocol (DHCP), Domain Name Server (DNS), Network Address Translation (NAT-ALG), which are used to provide seamless mobility between the GPRS/UMTS networks and the WLAN network when a mobile node roams, allowing for such mobile nodes to re-authenticate and be provided with the capability of keeping sessions alive without requiring the end IP hosts to close and re-establish a new session. The service layer 205 also contains the functionality of mapping IP addresses to GTP tunnel Ids (TIDs). For example, this allows the mobile nodes to keep an existing IP address assigned in the source GPRS/UMTS network or alternatively to be assigned a new IP address, and for a translation of the new IP address to the old IP address to be performed (and vice-versa) so the Internet hosts/services/servers can keep the connection/session alive or current association with the mobile node.

In FIG. 2, while the mobile node 140 still receives cellular service from the cellular network 100, its WLAN client 141 continuously scans for the presence of WLAN radio coverage, action 204. When the mobile node 140 enters a coverage area of the WLAN 102, for example, specifically a WLAN hotspot covered by the AP 136, it receives a WLAN advertisement broadcast message 206 informing the mobile node 140 of the presence of and adequate WLAN radio service. Responsive to the broadcast message 206, the mobile node 104 sends via the AP 136 an Access Request message 208 comprising mobility information 210 to the WIG node 132.

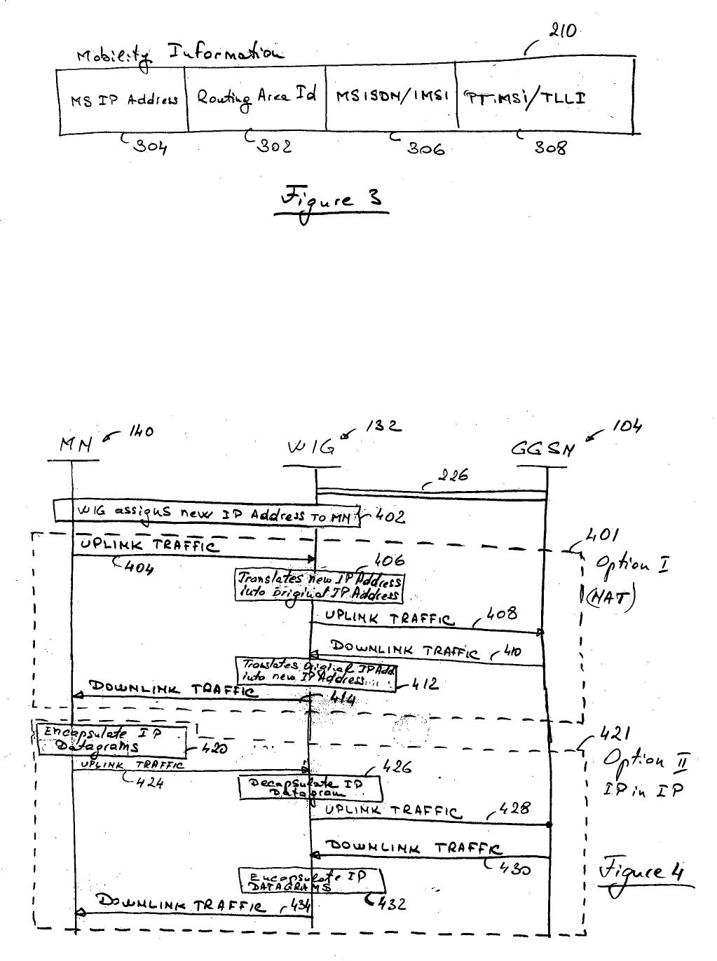

Reference is now made to FIG. 3, which is an exemplary high-level representation of the mobility information 210 sent from the mobile node 140 to the WLAN 102 in relation with the handoff of the mobile node 140 from the cellular network 100 to the WLAN 102. The function of the mobility information 210 is to inform the target WIG node 132 of the location where information about the roaming mobile node can be found, in order to complete a successful handoff of the mobile node toward the WIG node 132. For this purpose, the mobility information 210 may comprise Routing Area Identification (RAI) information 302 identifying the source routing area 114, the IP address 304 originally assigned by the cellular network 100 to the mobile node 140, and/or the Mobile Station ISDN (MSISDN) identifier and/or the International Mobile Subscriber Identity (IMSI) 306 and/or the Packet Temporary Mobile Subscriber Identity (PTMSI) or a Temporary Logical Link Identity (TLLI) 308.

With reference being now made back to FIG. 2, once the WIG node 132 is provided with the appropriate mobility information 210, in action 212 it can identify the source SGSN 110 based, for example, on the RAI information 302 provided within the mobility information 210. For example, the WIG node 132 may translate the RAI information 302 into an identity of the source SGSN 110, such as for example in the IP address of the SGSN 110. This is possible because there is always a one-to-one relation between a routing area and its corresponding SGSN, and because the WIG node 132 may comprise a table storing such a correspondence between the RAI information and the identity of the corresponding SGSNs of an entire cellular network.

Once the source SGSN 110 is identified by the WIG node 132 in action 212, the WIG node 132 sends an SGSN Context Request message 214 for requesting from the source SGSN 110 PDP Context information handled by the SGSN for the mobile node 140, and in turn, receives an SGSN PDP Context response message 216 with the requested information. If the reception of message 216 is performed successfully, the WIG node 132 responds to the source SGSN 110 with an SGSN Context Acknowledgment message 218. In action 220, the WIG node 132 sends an Update PDP Context message to the GGSN 104 as identified in the SGSN Context Response Message 216, to inform the latter of the successful handoff of the mobile node 140 from the source SGSN 110 to the WIG node 132. The GGSN 104 updates its GTP table in action 222 to reflect the change of SGSN node, and confirms the successful outcome of action 222 in action 224 with an Update PDP Context Response message sent to the WIG node 132. Finally, a GTP tunnel 226 is established between the WIG node 132 and the GGSN 104, so that data services can be provided to the mobile node 140 by the WLAN network 102 via the WIG node 132.

Reference is now made to FIG. 4, which is an exemplary nodal operation and signal flow diagram of various possible routing mechanisms that the present invention may use once the GTP tunnel 226 is successfully established between the target WIG node 132 and the GGSN 104, i.e. once the mobile node 140 has been successfully handed-off to the WLAN 102. According to the routing mechanisms described in FIG. 4, the WIG node 132 assigns a new IP address to the roamed mobile node 140, action 402.

According to a first variant of the preferred embodiment of the invention, herein called Network Address Translation (NAT) 401, when uplink traffic 404 occurs, i.e. data traffic from the mobile node to the WLAN, the WIG node 132 receives uplink IP datagrams from the mobile node 140 wherein the IP datagrams comprise the IP address newly assigned to the mobile node by the WIG node 132. Upon receipt of the IP datagrams, in action 406, the WIG node 132 translates the newly assigned IP address present in each such uplink IP datagram into the original IP address the mobile node had before the handoff, and which the WIG node 132 received from the mobile node 140 in action 208, previously described in relation to FIG. 2. The IP datagrams with the translated IP address are then relayed to the GGSN 104 via the GTP tunnel 226, action 408, so that they can be appropriately routed to their destination point with the originally assigned IP address of the mobile node.

In an analogous manner, when downlink traffic 410 is received by the WIG node 132 from the GGSN 104 via the GTP tunnel 226, i.e. traffic that is destined to the mobile node 140, the IP datagrams destined to the mobile node 140 contain the original IP address of the mobile node 140 that was assigned before the handoff. Therefore, the WIG node 132 translates the original IP address of the mobile node 140 into the new IP address assigned by the WIG node 132, action 412, and relays the IP datagrams with the translated IP address to the mobile node 140, action 414.

According to a second variant of the preferred embodiment of the invention, herein called IP in IP 421, when the mobile node 140 provided with a new IP address by the WIG node 132 desires to send IP datagrams in the uplink, it first encapsulates the IP datagrams in which it identifies itself with the original IP address into IP datagrams identified with its newly assigned IP address, action 420. When such uplink traffic 424 occurs, the WIG node 132 receives the uplink IP datagrams and, in action 426 decapsulates the received IP datagrams so as to leave only the IP datagrams identified with the original IP address of the mobile node 140. The decapsulated IP datagrams are then relayed to the GGSN 104 via the GTP tunnel 226, action 428.

In an analogous manner, the downlink traffic 430 is received by the WIG node 132 from the GGSN 104 via the GTP tunnel 226, wherein the IP datagrams destined to the mobile node 140 contain the IP address of the mobile node 140 that was assigned before the handover. Therefore, the WIG node 132 encapsulates the received IP datagrams into IP datagrams wherein the mobile node 140 is identified with the new IP address assigned by the WIG node 132, action 432, and relays the encapsulated IP datagrams to the mobile node 140, action 434.

Based upon the foregoing, it should now be apparent to those of ordinary skills in the art that the present invention provides an advantageous solution, which offers an advantageous method and system allowing for the seamless roaming of a mobile node from a GRPS or UMTS based cellular network into a WLAN network without any IP connection/session interruption. According to the present invention, the handoff from the cellular network to the WLAN network is performed in a manner which is totally transparent to the end-user, and the invention allows for the re-use of the existing cellular network architecture, by limiting the changes required for its implementation solely to the WIG node 132 and to the WLAN client present in the mobile node, as described hereinbefore. Although the system and method of the present invention have been described with particular reference to certain radio telecommunications messaging standards, it should be realized upon reference hereto that the innovative teachings contained herein are not necessarily limited thereto and may be implemented advantageously with any applicable radio telecommunications standard such as for example but not limited to 802.11, 802.11a, 802.11b, 802.11 g, 802.16, 802.16a (WIMAX), 802.20 etc, so that the mobile node handoff can be performed from a cellular network of any type to a WLAN equipped with a WIG node, as described. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for handing off a Mobile Node (MN) from a cellular network to a Wireless Local Area Network (WLAN), the method comprising the steps of:
a) receiving at a WLAN Integration Gateway (WIG) node mobility information relative to the MN;
b) identifying by the WIG node a source Service GPRS Support Node (SGSN) that lastly serviced the MN in the cellular network based on the mobility information;
c) obtaining by the WIG node Packet Data Protocol (PDP) Context information relative to the MN from the identified source SGSN;
d) establishing a GPRS Tunnelling Protocol (GTP) tunnel for use by the MN between the WIG node and a Gateway GPRS Support Node (GGSN).

2. The method claimed in claim 1, wherein step a) comprises the step of:
a.1) sending from the MN to the WIG node, via an Access Point (AP) of the WLAN, the mobility information.

3. The method claimed in claim 2, wherein the mobility information comprises:
an IP address assigned to the MN by the cellular network; and
Routing Area Identification (RAI) information relative to a routing area where the MN was serviced in the cellular network before the handoff to the WLAN.

4. The method claimed in claim 3, wherein the mobility information further comprises at least one identifier from the set of identifiers consisting of:
a Mobile Station Integrated Services Digital network Number (MSISDN);
an International Mobile Subscriber Identity (IMSI);
a Packet Temporary Mobile Subscriber Identity (PTMSI); and
a Temporary Logical Link Identity (TLLI).

5. The method claimed in claim 3, wherein step b) comprises the step of:
b.1) translating by the WIG node the RAI information received from the MN into an identification of the source SGSN.

6. The method claimed in claim 1, wherein step d) comprises the step of:
d.1) sending a PDP Context Update message from the WIG node to the GGSN.

7. The method claimed in claim 6, wherein step d) further comprises the step of:
d.2) responsive to a receipt of the PDP Context Update message by the GGSN, updating by the GGSN a GTP routing table of the GGSN.

8. The method claimed in claim 1, further comprising the steps of:
e) assigning by the WIG node a new IP address to the MN that was originally provisioned with an original IP address by the cellular network;
f) for MN's uplink traffic, the WIG node
translating the new IP address of the MN into the original IP address for each received IP datagram generated by the MN that comprises the new IP address;
relaying uplink IP datagrams with the original IP address to the GGGN over the GTP tunnel;
g) for MN's downlink traffic, the WIG node
translating the original IP address of the MN into the new IP address for each received IP datagram destined to the MN; and
relaying downlink IP datagrams with the new IP address to the MN.

9. The method claimed in claim 1, further comprising the step of:
e) assigning by the WIG node a new IP address to the MN that was originally provisioned with an original IP address by the cellular network;
f) for MN's uplink traffic, the WIG node
receiving IP datagrams generated by the MN, wherein each one of the IP datagrams comprises the new IP address of the MN and encapsulates another IP datagram comprising the original IP address of the MN;
decapsulating each one of the IP datagrams generated by the MN so as to leave the IP datagrams comprising the original IP address of the MN;
relaying in the uplink the decapsulated IP datagrams to the GGGN over the GTP tunnel;
g) for MN's downlink traffic, the WIG node
receiving IP datagrams destined to the MN, wherein each one of the IP datagrams comprises the original IP address of the MN;
encapsulating each one of the IP datagrams into an IP datagram comprising the new IP address of the MN; and
relaying to the MN the encapsulated IP datagrams.

10. A Wireless Local Area Network Integration Gateway (WIG) node for use in a Wireless Local Area Network (WLAN), the WIG node comprising:
a WLAN functionality for supporting data communications with WLAN clients, the WLAN functionality receiving mobility information relative to a roaming Mobile Node (MN) equipped with a WLAN client;
a service layer identifying based on the mobility information a source Service GPRS Support Node (SGSN) that lastly serviced the MN in a cellular network; and
a GTP stack module for supporting General Packet Radio Service (GPRS) Tunnelling Protocol (GTP) communications, the GTP stack obtaining Packet Data Protocol (PDP) Context information relative to the MN from the identified source SGSN, and establishing with a Gateway GPRS Support Node (GGSN) a GTP tunnel for use by the MN.

11. The WIG node claimed in claim 10, wherein the MN sends the mobility information to the WIG node via an Access Point (AP) of the WLAN.

12. The WIG node claimed in claim 11, wherein the mobility information comprises:
an IP address assigned to the MN by the cellular network; and
Routing Area Identification (RAI) information relative to a routing area where the MN was serviced in the cellular network before a handoff to the WLAN.

13. The WIG node claimed in claim 12, wherein the mobility information further comprises at least one identifier from the set of identifiers consisting of:
a Mobile Station Integrated Services Digital network Number (MSISDN);
an International Mobile Subscriber Identity (IMSI);
a Packet Temporary Mobile Subscriber Identity (PTMSI); and
a Temporary Logical Link Identity (TLLI).

14. The WIG node claimed in claim 12, wherein for identifying the source SGSN, the service layer of the WIG node translates the RAI information received from the MN into an identification of the source SGSN.

15. The WIG node claimed in claim 10, wherein for establishing the GTP tunnel, the GTP stack sends a PDP Context Update message to the GGSN.

16. The WIG node claimed in claim 10, wherein the WIG node assigns a new IP address to the MN that was originally provisioned with an original IP address by the cellular network, and
for MN's uplink traffic, the WIG node:
translates the new IP address of the MN into the original IP address for each received IP datagram generated by the MN that comprises the new IP address;
relays uplink IP datagrams with the original IP address to the GGGN over the GTP tunnel;
for MN's downlink traffic, the WIG node:
translates the original IP address of the MN into the new IP address for each received IP datagram destined to the MN; and
relays downlink IP datagrams with the new IP address to the MN.

17. The WIG node claimed in claim 10, wherein the WIG node assigns a new IP address to the MN that was originally provisioned with an original IP address by the cellular network, and
for MN's uplink traffic, the WIG node:
receives IP datagrams generated by the MN, wherein each one of the IP datagrams comprises the new IP address of the MN and encapsulates another IP datagram comprising the original IP address of the MN;
decapsulates each one of the IP datagrams generated by the MN so as to leave the IP datagrams comprising the original IP address of the MN;
relaying in the uplink the decapsulated IP datagrams to the GGGN over the GTP tunnel;
for MN's downlink traffic, the WIG node:
receives IP datagrams destined to the MN, wherein each one of the IP datagrams comprises the original IP address of the MN;
encapsulates each one of the IP datagrams into an IP datagram comprising the new IP address of the MN; and
relays to the MN the encapsulated IP datagrams.
